(19) United States
(12) Patent Application Publication
(10) Pub. No.: US 2004/0014604 A1
(43) Pub. Date: Jan. 22, 2004

(54) Method for producing large flat high-temperature superconductors

(76) Inventors: Alexandr Konstantinovich Shikov, Moscow (RU); Alexandra Evgenievna Vorobieva, Moscow (RU); Igor Ivanovich Akimov, Moscow (RU); Alexandr Pavlovich Emelianov, Moscow (RU); Oleg Valentinovich Dokman, Moscow (RU)

Correspondence Address: WILLIAM COLLARD, COLLARD & ROE, P.C., 1077 NORTHERN BOULEVARD, ROSLYN, NY, 11576, US

(21) Appl. No.: 10/344,116

(22) PCT Filed: Dec. 22, 2000
(86) PCT No.: PCT/RU00/00521

(30) Foreign Application Priority Data
Aug. 7, 2000 (RU) 2000121196

(51) Int. Cl. H01B 1/00

(52) U.S. Cl. 505/100

(57) ABSTRACT

The invention relates to engineering superconductivity, in particular, to a device for and a method of producing wide flat superconductors aimed at manufacturing electrical-engineering products.

The method for producing flat superconductors comprises: forming a hollow metallic ampoule, filling the ampoule with superconducting compound or semi-product powder calculated on a basis of the final monofilamentary conductor filling factor of 20-75%, reducing the resultant ampoule—powder system to a thickness of 0.35-5 mm at a reduction ratio of 1-20% per pass, cutting the thus-reduced ampoule—powder system into specified-length component parts, forming a complex billet by placing in a sheath of the complex billet appearing as a hollow section having an oval or rectangular cross-section, a required amount of specified-lengths component parts or of specified-lengths component parts and reinforcing elements calculated on a basis of the final multifilamentary conductor filling factor of 25-70%, reducing the complex billet to the required dimensions at a reduction ratio of 1-18% per pass, and thermomechanical treatment of the billet.

The resultant superconductors are comprised of the elements of high-temperature superconducting ceramics put in layers into a sheath, or of the elements of high-temperature superconducting ceramics put in layers into a sheath and of the reinforcing elements placed between the elements of high-temperature superconducting ceramics, the ratio between a total area of the elements of high-temperature superconducting ceramics and a maximum overall dimension is 0.03 m-2 m and 0.03 m-3 m, respectively.

A minimum critical current of the resultant flat superconductors having a width of up to 1 m (up to 1.5 m 1.5 m when using the reinforcing elements) is as high as 560 A. The fields of application of the flat superconductors are extended due to an increased width of both short-length and long-length multifilamentary superconductors.

### TECHNICAL FIELD

The invention relates to electrical engineering and more specifically, to high-temperature superconductors and may be used to produce superconductors having the critical parameters and dimensions allowing a considerable extension of a range of electrical-engineering products the manufacture of which involves use of high-temperature superconducting materials.

### BACKGROUND ART

Since the discovery of high-temperature ceramic oxide superconductors studies into their chemical and physical properties, as well as their capabilities have been dealt with in many published papers. A large number of titles of protection have been issued to protect both methods of producing superconducting materials and conductors on their base, as well as methods of improving their mechanical properties and the critical characteristics of high-temperature superconductors.

At present, oxide superconducting materials have found broad application in electrical engineering and in the technical fields related to the usage of magnetic fields.

To improve mechanical properties and provide for a possibility of producing long-length conductors a superconducting ceramic material is sheathed with a metal, as a rule, silver or an alloy based thereon, since it has been shown that these materials do not lead to a degradation of superconducting properties of ceramics, make it possible (under definite conditions) to reach a perfect texture of the ceramic core, as well as to densify ceramics in the process of reduction. However, in case of monofilamentary conductors the mechanical properties of silver are insufficient to ensure the strength of a conductor that would be adequate to create windings thereof for use in high magnetic fields.

In the papers of a number of researchers, e.g., S. X. Dou, N. K. Liu, J. C. Guo in Appl. Phys, 60, 1992, p.2929; H. Makai et al. in Paper presented at the MRS Spring Meeting, San Francisco, Calif., Apr. 27-May 1, 1992, and others, it has been demonstrated that the stability of multifilamentary conductors is much increased compared to that of the monofilamentary ones. In addition, a multifilamentary design is more reliable because a damage to a single filament does not result in a failure of the entire product wherein such superconductor is used. If the sequence of filament arrangement and operational conditions are selected properly it is possible to produce long-length (up to 100 m and more) wires and tapes having uniform filaments without breaking the superconducting layer, and high critical characteristics (see above). The simplest and most mastered method yielding reproducible results and suitable to produce high-temperature superconductors such as wires and tapes is the so-called powder-in-tube technique comprising the following three steps:

preparing an original powder (precursor) to form superconducting ceramics having a required chemical and phase compositions;

forming a billet to produce a composite conductor; in case of a multifilamentary conductor a complex billet is formed from a number of cut lengths of prefabricated monofilamentary wires having a required diameter or thickness, sheathing them with a metal, basically, with silver or an alloy based thereon; a monofilamentary wire is produced by mechanical reduction of a tubular billet filled with powder, namely, a precursor;

thermomechanical treatment of a complex billet that comprises alternate cycles of heat treatment and mechanical reduction. The necessity of repeating those cycles to form a high-temperature superconducting phase having a required composition and structure, to increase critical current values, and to relieve stresses has been proved experimentally.

The information about the powder-in-tube method was published in a number of papers, namely: K. Heine et al., High-filed critical current densities in Bi₂Sr₂CaCu₂Oₓ/Ag wires, Appl. Phys. Lett., 55(23), December 1989; Kumakura et al., Bi(Pb)—Sr—Ca—Cu—O Superconducting Composite Tapes Prepared by the Powder Method Using an Ag Sheath, J. Appl. Ohys. 67(7), April 1990, p.p. 3443-3447; Haldar P. Smd Motowidlo L., Processing High Critical Current Density Bi-2223 Wires and Tapes, JOM, Vol.44, #10, October 1992; Schuster Th. et al., Current capability of filaments depending on their position in Bi(Pb)₂Sr₂Cu₃)O_{10+δ} multifilament tapes, App. Phys. Lett., Vol.69, p.p. 1954-1956, 1996, and others.

A large number of titles of protection have been issued for the methods aimed to produce high-temperature multifilamentary composite superconductors, said methods being based on the powder-in-tube technique.

The technical solutions protected by the granted patents are aimed at achieving such objects as an increasing in the critical current values, critical current density and improvement in mechanical strength. Among such documents are U.S. Pat. No. 5,369,089, IPC H 01 L 39/24, 1994; International application #99/13,517, IPC H 01 L 39/24, 1999; International application #99/33,123, IPC H 01 B 12/50, 1999; International application N 00/38,251, IPC H 01 L 39/24, 2000, and others.

A tube filled with a powder precursor (of the ampoule—powder system) is subjected to reduction using any A method of mechanical treatment (reduction) that allows of reducing the cross-sectional area of a billet (i.e., reduction, drawing, rolling, pressure molding). When said mechanical treatment is carried out at a high reduction ratio, said treatment is followed by heat treatment (to relieve mechanical stress in metal) at temperatures that do not bring about a reaction between precursor components, or melting or growing grains of the metal said sheath is made from. The operations of reduction in cycles of thermomechanical treatment of a composite billet are usually carried out by rolling or drawing by means of which a required grain orientation is attained in the precursor of a superconducting material which promotes the growth of well textured grains of a sintered superconducting material in the course of the subsequent heat treatment. A series of heat treatment procedures is also typical of the thermomechanical treatment stage—in the process of annealing a reaction of forming a ceramic superconducting material occurs as the final phase resulting from the grain orientation process.

Said thermomechanical treatment may be carried out as it is described, e.g., in the work by S. X. Dou et. al., H. Mukai et. al., P. Haldar and L. Motowidlo, as well as in U.S. Pat. No. 5,369,089, International application #99/33,123 mentioned above, and in other published papers.

The known methods make it possible to produce both short- and long-length composite tape-like superconductors comprising a sheath made of silver or an alloy on the base thereof within which elements of high-temperature superconducting ceramics are arranged in layers. The width of such superconductors makes up usually not more than 3-6 mm on the average and from 10 to 15 mm as a maximum); the ratio between a total surface area of the elements of high-temperature superconducting ceramics and the maximum overall dimenions of a flat superconductor is not in excess of 0.03 m per superconducting layer, the critical current value amounting to 70 A.

As it has been mentioned above, the technical objects of the known methods consist basically in increasing critical current density, improving the mechanical strength of superconductors and reducing the cost price of the latter. Said objects are governed by the field of their application and requirements of a sale market. Conductors of this kind are used to produce cables, magnets, generators, transformers, etc. The consumer-demanded properties of superconductors produced by the known methods adequately conform to the requirements imposed thereon.

However, at present a practical interest has arisen in high-temperature superconductors in the field of manufacture of electrical-engineering products, e.g., magnetic screens, current leads, and so on, the manufacture of which involves the use of superconducting materials that feature not only high mechanical strength and critical current but also adequately high standard size. In view of this fact, to-day of urgency is a high-efficiency continuous procedure of producing such superconducting materials the technique of which is simple and needs no basically novel equipment. Since the most favorable conditions of carrying high currents in oxide superconductors take place at the ceramics—sheath interface to reach a high critical current value, the surface area of the ceramics—sheath interface need be increased. In terms of design this is most easily attainable by increasing the width of a superconductor. However, it is an intricate task both in terms of reduction procedures aimed at forming a conductor of a required standard size without breaking the integrity of a sheath and the core shape and in terms of thermomechanical treatment that comprises general stages of heat treatment with intermediate reduction procedures carried out at intervals between said stages or heat treatment aimed at forming a phase having a required composition and structure within a ceramic core.

The closest to the method proposed herein, as to a desirable technical result, is a method of producing bismuth-oxide ceramics superconductor as disclosed in U.S. Pat. No. 5,369,089 mentioned hereinbefore, said method using basically the powder-in-tube technique. The method comprises the following steps: preparing an original powder to produce superconducting ceramics, forming an ampoule—powder system; subjecting the ampoule—powder system to reduction (reduction), predominantly by being drawn, until a 1-mm diameter is attained, followed by rolling down to a 0.2 mm thickness and the length of the order of 20 m; forming an intricately shaped billet by putting the resultant tapes on one another; heat-treatment of said billet at 840° C. for 50 hours with a view to effecting interdiffusion of metallic components; mechanical treatment by rolling at a reduction ratio up to 40% per pass; and heat treatment for 50 hours at 840° C.

The method allows of producing flat long-length superconductors featuring high mechanical properties, critical current magnitudes and critical current density values in liquid nitrogen equalling 240 A and 22,000 A/cm², respectively.

However, the method mentioned above is incapable of increasing the width of superconductors to 1-1.5 m which substantially narrows the range of electrical-engineering components whose production involves use of high-temperature superconducting materials.

In terms of the technical essence, the technical solution closest to the herein-proposed one is a method of producing a multifilamentary tape described in the paper by Haldar P. And Motowidlo L. Entitled Processing High Critical Current Density Bi-2223 Wires and Tapes, JOM, Vol.44, #10, October 1992, p.p. 54-58, said method comprising: producing round cross-section hollow metallic ampoule (tube), filling said tube with bismuth ceramics powder, drawing the resultant ampoule—powder system through a drawing die having a round cross-section calibrating parallel, to a specified diameter; cutting the thus—drawn ampoule—powder system into specified-lengths; forming a complex billet by putting a required number of preset-length component parts in a metal billet of a round cross-section sheath, reduction of a complex billet first by being drawn to a required diameter and then by rolling to a required dimensions of a tape-shaped superconductor and thermomechanical treatment involving heat treatment procedures in two stages with intermediate rolling carried out at intervals between the heat treatment stages.

The disadvantages of said method reside in both too small a width of tapes basically amounting to 3-6 mm and not exceeding 10-15 mm which fails to meet the ever growing demands for high-temperature superconducting compounds of different standard size that are required for producing electrical-engineering products, as well as too low critical currents due to a small area of the ceramics-sheath interface in narrow tapes compared to wider ones.

No other published references dealing with methods of producing flat superconducting materials having a width in excess of 15 mm and a critical current value exceeding 240 A have been revealed in the course of search procedure.

### DISCLOSURE OF THE INVENTION

It is a primary and essential object of the present invention to provide a method of producing high-temperature superconductors having high critical current values, an adequate width of both short- and long-length multifilamentary tapes with the aim of extending the field of their application.

Said object is accomplished due to a solution of the technical problem residing in increasing the surface area of a ceramic superconducting material that contacts a metal, since it is at the ceramics—metal interface in composite superconductors where the most favorable conditions for high currents to flow are provided.

Said technical problem is solvable due to the provision of a combination of steps constituting the powder-in-tube method the process parameters of which have been found experimentally and allow of overcoming the abovementioned disadvantages inherent in the now-existent and published prior-art methods.

In accordance with the herein-proposed invention, in a method which comprises forming a hollow metallic ampoule, filling said ampoule with the powder of a superconducting material or a semi-product, treating the resultant ampoule powder system by reduction to a required dimensions, cutting the thus-treated ampoule—powder system into a number of specified-lengths, forming a complex billet by putting a required number of preset-length component parts in a metal billet of a round cross-section sheath, treating the complex billet by its being reduced to a required dimensions, and subjecting said billet to thermomechanical treatment, according to the invention, said hollow metallic ampoule is filled with a powder of a superconducting compound or semi-product of a required composition calculated on a basis of a final factor of filling a monofilamentary conductor equal to 20-75%, the ampoule—powder system is subject to treatment by being reduced to a thickness of 0.35-5 mm at a reduction ratio of 1-20% per pass, a sheath for a complex billet is fabricated as a hollow section of an oval-like or rectangular cross section, filled with a required number of specified-length component parts of the thus-treated ampoule—powder system and of the reinforcing elements of a required type arranged in a required manner with respect to one another on a basis of the final factor of filling the multifilamentary conductor equal to 25-70%; whereupon the complex billet is treated by being reduced to the required dimensions of 1-8% per pass; thermomechanical treatment comprising several stages of heat treatment with intermediate reduction procedures carried out at intervals between them is carried on at a temperature and during said stages that ensure the formation of a superconducting phase of a required composition and structure in the ceramics.

The ampoule—powder system is subjected to reduction by lengthwise—cross rolling, or lengthwise rolling, or else cross rolling at a reduction of 1-20% per pass or by being drawn through a roller die at a reduction ratio of 1-18% per pass. A metallic sheath of the oval-like cross-section is produced from a round cross-section billet by upsetting to dimensions. The complex billet is treated to a required dimensions by lengthwise—cross rolling, or lengthwise rolling, or cross rolling at a reduction ratio of 1-18% per pass or by being drawn through a roller die at a reduction ratio of 1-16% per pass.

Furthermore, the intermediate reduction procedures involved in the thermomechanical treatment is carried out by a lengthwise—cross rolling, or lengthwise rolling, or cross rolling at a reduction ratio of 1-20% per pass, or by being drawn through a roller die at a reduction ratio of 2-15% per pass.

When producing a flat superconductor based on yttrium ceramics of the Y-123 type, or bismuth ceramics of the Bi-2212, Bi-2223 types the filling of an ampoule with superconducting compound powder or semi-product calculated on a basis of the final filling factor of monofilamentary conductor equal to 20-75% ensures a required ratio between ceramics and sheath materials and the possibility of subjecting an ampoule—powder system to process operations (e.g., reduction, annealing) required for the fabrication of a tape. The reduction of an ampoule—powder system to 0.35-5 mm thickness by being drawn through a roller die at a reduction ratio of 1-18% per pass, lengthwise—cross rolling, or lengthwise rolling, or cross rolling at a reduction ratio of 1-20% per pass ensures the production of a deformed ampoule—powder system having a required standard size the specified-length component parts of which are adapted to form a complex billet.

Rectangular or oval-like cross-sections provide in turn the production of a complex billet having a required cross-section.

The formation of a sheath billet by upsetting to dimensions of a round cross-section billet ensures the production of a complex billet having an oval-like cross-section. The complex billet of the oval-like cross-section or of the rectangular cross-section is produced after the metallic billet of a sheath has been packed with a required number of specified-length component parts of a treated ampoule—powder system or with a required number of specified-length component parts of deformed ampoule—powder system and reinforcing elements calculated on a basis of the final factor of filling a multifilamentary conductor equal to 25-70%. Such a complex billet is subjected to reduction by skipping the process of drawing through a die having a calibrated round cross-section.

The reduction of a complex billet by lengthwise—cross rolling or lengthwise or cross rolling at a reduction ratio of 1-18% per pass or by being drawn through a roller die at a reduction ratio of 1-16% per pass to a required dimensions (e.g., 0.35-0.45 mm) ensures a required tape shape and a required state of a ceramic core (basically in terms of its density). In this case drawing through a roller die (compared to that through a die with a calibrated round section) drastically reduces the frictional force, thereby improving the quality of a multifilamentary tape shapes due to a uniform distribution of strains and stresses across the entire section. The reduction produced by cross and lengthwise cross rolling which is in fact an alternation of lengthwise and cross rolling applied in a specified sequence ensures the required characteristics (e.g., length, width, thickness) of shorter tapes (the length being governed by the shape of the rollers used), while the reduction produced by lengthwise rolling and drawing through a roller die ensures the required characteristics of both shorter and longer tapes.

Thermomechanical treatment that involves several stages of heat treatment with intermediate reduction procedures carried out at intervals between said stages, at a reduction ratio of 1-20% per pass provides for the formation of a phase having a required composition and structure within the ceramic core. In this case intermediate reduction procedures by lengthwise rolling at a reduction ratio of 1-20% per pass and by being drawn through a roller die at a reduction ratio of 2-15% per pass provide for the required characteristics of tapes having various length while intermediate reduction procedures by cross rolling and lengthwise—cross rolling at a reduction ratio of 1-20% per pass provide for the required characteristics of shorter tapes (the length of a tape being governed by the shape of rollers).

When an ampoule is filled with powder of a superconducting compound or semi-product calculated on the basis of the final monofilamentary filling factor below 20% in the course of reduction, there occurs a breakage of a ceramic core as a result of the joining of the sheath material located on different sides of the core. When an ampoule is filled with a powder of a superconducting compound or semi-product calculated on the basis of a final monofilamentary filling factor above 75%, they fail to obtain a required thickness of ceramics after the ampoule—powder system having been reduced.

If the reduction of an ampoule—powder system to a thickness of 0.35-5 mm effected at the preceding stage by using lengthwise—cross, or lengthwise, or cross rolling or drawing through a roller die at a reduction ratio below 1% per pass the geometrical dimensions of a wire are affected, i.e., the so-called wavy shape as for length appears. If the reduction of an ampoule—powder system is effected by using lengthwise—cross, or lengthwise, or cross rolling at a reduction ratio above 20% per pass, or drawing through a roller die at a reduction ratio above 18% per pass, the sheath is ruptured (from fine cracks to its complete disruption) which results in a wire breakage.

When a complex billet is formed by filling a metallic sheath billet having a rectangular or oval-like cross-section, with a required amount of specified-length component parts of an ampoule—powder system or with a required amount of specified-length component parts of an ampoule—powder system and reinforcing elements calculated on a basis of the final filling factor below 25% as applied to a multifilamentary conductor (e.g., a tape) they fail to produce a required amount of ceramic filaments which results in an abnormally high consumption of a sheath material (e.g., silver) and in a drastic reduction in the overall current density (current related to a section of the whole conductor including ceramics and sheath areas), while an increase in the filling factor above 70% leads to joining ceramic filaments in the process of complex billet reduction which affects the geometric shape of the wire and results in a decrease of the critical current density (current related to the cross-sectional area of ceramics.

If a complex billet is reduced to a required dimension (e.g., 0.38 mm) by being drawn through a roller die or by lengthwise—cross or cross or lengthwise rolling at a reduction ratio below 1% per pass, the geometrical dimensions of a wire are affected, i.e., the so-called wavy shape appears as for length. If a complex billet is reduced by being drawn through a roller die at a reduction ratio above 16% per pass or by lengthwise—cross, or cross, or lengthwise rolling at a reduction ratio above 18% per pass, sheath ruptures (from fine cracks to its complete disruption) are liable to occur which results in a breakage of the wire.

When intermediate reduction procedures (at the thermomechanical treatment stage) are carried out by being drawn through a roller die at a reduction ratio below 2% per pass or by a lengthwise—cross, or cross or lengthwise rolling at a reduction ratio below 1% per pass the geometrical dimensions of a wire are affected, i.e., the so-called wavy shape appears as for length. When intermediate reduction procedures are accomplished by being drawn through a roller die at a reduction ratio above 15% per pass or by lengthwise cross, or cross, or lengthwise rolling at a reduction ratio above 20% per pass, the sheath is liable to rupture (from fine cracks to complete disruption) are liable to occur which results in a breakage of the wire.

The thermomechanical treatment of high-temperature superconducting ceramic independent of the type carried out at temperatures below or above the indicated temperature ranges fails to form a superconducting phase having a required composition and structure within a ceramic core.

The particular operation carried out in the described sequence at the established process parameters have lead to a novel technical result, namely, an increase in the critical current of a conductor due to increasing the surface area of the ceramics-sheath interface, as well as to extending the range of application due to an increase in the width of both short- and long-length multifilamentary tapes.

In a superconductor (e.g., as a tape) comprising the elements of high-temperature superconducting ceramics sheathed in layers, the ratio between a total surface area of superconducting ceramics to a unit maximum overall-dimenions of a superconductor is increased to 0.03-2 m per layer of superconducting ceramics by increasing the superconductor width from 3 mm to 1 m.

In a superconductor comprising the elements of high-temperature superconducting ceramics sheathed in layers and reinforcing elements that are arranged layer-by-layer between elements of high-temperature superconducting ceramics by increasing a superconductor width from 3 mm to 1.5 m, the ratio between a total surface area of superconducting ceramics and specific maximum overall-dimenions of superconductor is increased to 0.03-3 m per layer of superconducting ceramics. In such a superconductor the ratio between a total surface area of reinforcing elements and the maximum overall-dimenions of a flat superconductor is also equal to 0.03-3 m per layer of reinforcing elements.

Both the sheath and reinforcing elements are made of a material which does not degrade the superconducting properties of ceramics. The sheath may be made, e.g., from gold or silver, or silver-based alloys, e.g., silver-gold alloys or silver-nickel alloys. Reinforcing elements are fabricated, from, e.g., nickel or a silver-based hardened alloy, e.g., silver-nickel or silver-yttrium alloys.

A single or a few reinforcing elements are arranged in a layer or in layers between the elements of high-temperature superconducting ceramics in such a manner that the layers of reinforcing elements alternate with the layers of high-temperature superconducting element. In this case reinforcing elements appear as rods or plates.

As a result, a superconductor comprising the elements of high-temperature superconducting ceramics sheathed layer by layer or a superconductor comprising high-temperature ceramics and reinforcing elements arranged in a specified way with respect to each other at a ratio of a total surface area of superconducting ceramics to unit maximum overall-dimenions of a superconductor equalling 0.02-2 m and 0.02-3 m per layer of superconducting ceramics feature, respectively, an increase in the critical current due to an increase in the surface area of the ceramics-sheath interface due to an increase in the overall-dimenions of a superconductor.

The ratio of a total surface area of superconducting ceramics to the unit maximum overall-dimenions of superconductor increased to 0.02-3 m per layer of superconducting ceramics through extending the width of a superconductor results in a larger surface area of the ceramics-sheath interface and in a higher critical current.

With the ratio between a total surface area of superconducting ceramics to the unit maximum overall-dimenions of a superconductor increased to a value below 0.03 m per layer of superconducting ceramics neither the critical current of a superconductor nor its overall-dimenions are substantially increased.

The ratio of a total surface area of superconducting ceramics to the unit maximum overall-dimenions of a superconductor increased to a value in excess of 2 m (3 m when reinforcing elements are used) per layer of superconducting ceramics is limited, on the one hand, by the specific features of a reduction schedule and by the strength characteristics of a superconductor and, on the other hand, by the quality of the ceramics-sheath interface and the core shape. That is to say, when using the present-day equipment for plastic working of materials it is difficult to produce superconductors on the base of high-temperature superconducting ceramics at a ratio between a total surface area of superconducting ceramics and the unit maximum overall-dimenions of a superconductor exceeding 2 m (3 m when reinforcing elements are used) per layer of superconducting ceramics with a required quality of the ceramics-sheath interface, the shape of the ceramic core and the strength characteristics of the superconductor.

With the ratio between a total surface area of reinforcing elements to the unit maximum overall-dimenions of a superconductor is increased to a value below 0.03 m per layer of superconducting ceramics, the strength characteristics of the superconductor are not improved to a required level when its overall-dimenions are increased.

An increase in the ratio between a total surface area of reinforcing elements to the unit maximum overall-dimenions of a superconductor to a value exceeding 3 m per layer of superconducting ceramics is limited, on the one hand, by the specific features of the reduction schedule and by the strength characteristics of a superconductor and, on the other hand, by the quality of the ceramics-sheath interface and by the core shape. That is to say, when using the present-day equipment for plastic reducing of materials it is difficult to produce superconductors on the base of high-temperature superconducting ceramics at a ratio between a total surface area of superconducting ceramics and the unit maximum overall-dimenions of a superconductor exceeding 3 m per layer of superconducting ceramics with a required quality of the ceramics-sheath interface, the shape of the ceramic core and the strength characteristics of the superconductor.

A 0.03-3 m increase in the ratio between a total surface area of superconducting ceramics to the unit maximum overall-dimenions of a superconductor comprising the elements of high-temperature superconducting ceramics sheathed layer-by-layer, per layer of the superconducting ceramics, as well as a 0.03-3 m increase in the ratio between a total surface area of the superconducting ceramics to the unit maximum overall-dimenions of a superconductor per layer of the superconducting ceramics and arrangement of the reinforcing elements in the specified manner between the elements of high-temperature superconducting ceramics in such a way as to have the ratio between a total surface area of the reinforcing elements to the maximum overall-dimenions of a flat superconductor of 0.03-3 m per layer of the reinforcing elements yields a novel technical result, i.e., an increase in the critical current of a superconductor due to an increase in the surface area of the ceramic-sheath interface, as well as results in extending the field of application due to an increase in the width of both short- and long-length multifilamentary tapes.

### EMBODIMENTS OF THE INVENTION

The proposed invention makes it possible to produce, using the powder-in-tube technique, flat high-temperature superconductor up to 1.5 m wide having high critical characteristics. Using the invented method, superconductors may be produced on the base of oxide ceramic materials of a variety of compositions.

According to a first embodiment of the invention, an initial stage of the method involves the formation of an ampoule-powder system by filling a metallic ampoule made of silver or a silver-based hardened alloy, e.g., Ag+1% by weight Mg alloy, with a superconducting compound powder or semi-product. The ampoule is filled with said powder in a controlled environment in a vibration facility on a base of a final monofilamentary conductor filling factor of 20-75% depending on the ratio between the ceramics and the sheath materials, preferably, 40% for the Bi-2223 ceramics, 30% for the Bi-2212 ceramics, and 35% for the Y-123 ceramics. It has been found experimentally for all types of ceramics that upon filling an ampoule with said powder calculated on a base of a monofilamentary conductor filling factor below 20% in the course of reduction the sheath material links in various component parts which results in a rupture of a ceramic core. If the monofilamentary conductor filling factor exceeds 75% it is practically impossible to attain a required thickness of ceramics. Then the resultant ampoule—powder system is reduced to a thickness of 0.35-5 mm, preferably, of 1-2 mm depending on the specified width of a conductor. The reduction is carried out either by rolling or drawing through a roller die. To produce long-length superconductors an ampoule-powder system is subjected to drawing or lengthwise rolling while for short-length superconductor production apart from the above indicated methods, lengthwise and lengthwise—cross rolling are also effective. A reduction ratio of an ampoule—powder system is 1-20% depending on a required shape of a monofilamentary conductor (ceramic filament uniformity in longitudinal and cross sections). Upon reduction by rolling the preferred reduction ratio is 1-20% per pass while by being drawn through a roller die it is equal to 1-18%.

It has been proved experimentally for all types of ceramics that during the reduction of an ampoule-powder system in order to attain the abovementioned thickness using any one of the aforementioned methods at a reduction ratio below 1% per pass, the geometrical dimensions of a monofilamentary conductor are affected and wavy shape as for length occurs, while the reduction by rolling at a reduction ratio above 20% per pass (in a roller die it is more than 18% per pass) leads to incipient cracks occurring in the sheath; in some instances the sheath is fractured with the resultant breakage of the wire. A flat cross-section monofilamentary conductor produced by reducing the thickness of an ampoule powder system is cut into specified lengths which are adapted to form a complex composite billet by sheathing it with silver or an alloy based thereon, preferably an Ag+1% by weight Mg alloy. A hollow composite billet has preferably an oval or rectangular shape since it has to approach to a maximum extent the shape of a flat superconductor to be produced. The oval shape is provided by upsetting a round-shaped sheath to the required dimensions. The rectangular shape of a complex billet is produced by placing specified-length component parts of a monofilamentary conductor in layers into a box having a rectangular cross-section. To produce a superconductor of a required design the amount of specified-length component parts to form a complex billet is found by calculating, on a basis of a final multifilamentary flat superconductor filling factor of 25-70%, preferably, 30-40%. Monofilamentary conductors in a sheath of a complex billet are arranged depending on the required design of a superconductor which is dictated by the field of its application. The resultant complex billet is subjected to reduction to the required dimensions and shape, and to a necessary condition for a ceramic core. The reduction process is carried out either by rolling at a reduction ratio of 1-18% per pass depending on a required configuration of filaments and layers (uniformity of ceramic filament or layer in longitudinal and cross sections), or by being drawn through a roller die at a reduction ratio of 16%. Cross and lengthwise—cross rolling ensures the specified characteristics (length, width, thickness) of short-length tapes, while lengthwise rolling or drawing through a roller die ensures the specified characteristics both for short- and long-length tapes. The reduction by means of lengthwise—cross rolling is preferred for short-length tapes.

A flat superconductor resultant from the reduction procedures is subjected to thermomechanical treatment which involves several heat treatment procedures with intermediate reduction procedures. The temperature conditions, reduction ratio per pass during heat treatment procedures and intermediate reduction procedures, as well as the number and duration of thermomechanical treatment stages are on the whole defined by the type of each particular ceramics, to be more exact, by the conditions under which a superconducting phase formed within a ceramic core acquires a required composition and structure, as well as by a required configuration of the tapes produced.

When reducing a complex billet which pertains to all types of ceramics, the common ultimate values of a reduction ratios per pass are equal to 1-18% for rolling and to 1-16% for drawing through a roller die. As for the intermediate reduction procedures, these values are 1-20% and 2-15%, respectively. In the case of the ampoule—powder system reduction a shift of the boundary values of a reduction ratio per pass to one or the other side results in impaired superconductor geometrical dimensions or in a fracture of the sheath.

Intermediate reduction procedures by lengthwise rolling or drawing through a roller die ensure the specified characteristics of tapes having various lengths. Reduction by cross or lengthwise—cross rolling is effective for short-length tapes, whereas lengthwise—cross rolling is preferable for short-length tapes. The width of superconductors produced according to the first embodiment of the present invention is as large as 1 m.

In accordance with a second embodiment of the present invention, a complex billet is formed from an oval or rectangular cross-section sheath, specified-length component parts of a monofilamentary conductor of the required standard sizes produced in the same way as described above with reference to the first embodiment of the invention, as well as from reinforcing elements (rods or plates) of a required shape. Provision of reinforcing elements makes it possible to increase a superconductor width to as high as 1.5 m, whereas a maximum width of a superconductor attainable without use of said reinforcing elements is not to exceed 1 m due to problems relevant to affected configuration of a conductor and disturbed integrity of a large-size complex billet during reduction procedures.

Reinforcing elements are made from such materials that do not substantially deteriorate the superconducting properties of ceramics (e.g., hardened silver-based alloys, predominantly silver-nickel, silver-yttrium or silver-copper alloy). Reinforcing elements may be arranged in layers (single or a few reinforcing elements per layer), in alternating layers with respect to the layers of specified-length component parts of a monofilamentary conductor. The amount and arrangement of specified-length component parts of monofilamentary conductors and reinforcing elements are dictated by the design particulars with due account of the complex billet integrity to be retained during subsequent reduction, and by the requirements imposed on the configuration of a superconductor, as well as by the fields of superconductor application.

Reduction of a complex billet produced as described above is carried out in a way similar to that described with reference to the first embodiment of the invention.

Given below is a detailed description of the principle production operations of the method, according to the invention, whose process parameters (i.e., monofilamentary and multifilamentary product filling factors, reduction ratios per pass for all stages of the production process cycle, temperature conditions and duration of heat treatment stages) for particular types of high-temperature ceramics have been established experimentally.

To produce a high-temperature superconductor on the Y-123 type ceramics base, a hollow metallic ampoule is filled with the powder of superconducting yttrium ceramics of the Y-123 composition calculated on a basis of final monofilamentary conductor filling factor of 20-75%, an ampoule—powder system is reduced to attain a 0.35-5 mm thickness at a reduction ratio of 1-20% per pass, a complex billet is formed as calculated on a basis of the final multifilamentary flat superconductor filling factor of 25-70%, a complex billet is reduced to the required dimensions at a reduction ratio of 1-18% per pass, thermomechanical treatment is carried on at a temperature of 920-960° C. for 250-300 hours with intermediate reduction procedures of 1-2% per pass. In this case an ampoule—powder system is reduced by lengthwise—cross rolling, or lengthwise rolling, or cross rolling at a reduction ratio of 1-20% per pass, or by being drawn through a roller die at a reduction ratio of 1-18% per pass; a complex billet is reduced to the required dimensions by lengthwise cross rolling, or lengthwise rolling, or cross rolling at a reduction ratio of 1-18% per pass, or by being drawn through a roller die at a reduction ratio of 1-16% per pass; intermediate reduction procedures of the thermomechanical treatment is carried out by lengthwise—cross rolling, or lengthwise rolling, or cross rolling at a reduction ratio of 1-20% per pass, or by being drawn through a roller die at a reduction ratio of 2-15% per pass.

When filling a hollow metallic ampoule with a powdery superconducting compound or semi-product of yttrium ceramics of the Y-123 composition as calculated on a basis of the final monofilamentary conductor filling factor below 20%, a rupture of a ceramic core is liable to occur; with the monofilamentary conductor filling factor increased to more than 75% it is impossible to attain a required thickness of ceramics after an ampoule—powder system has been reduced. Upon reducing the thus-obtained ampoule—powder system to a thickness of 0.35-5 mm by using lengthwise—cross rolling, or lengthwise rolling, or cross rolling, or drawing through a roller die at a reduction ratio below 1% per pass, the geometrical dimensions of a conductor are affected and the so-called wavy shape as per length occurs. Upon reducing an ampoule—powder system by lengthwise—cross rolling, or lengthwise rolling, or cross rolling at a reduction ratio above 20% per pass, or by being drawn through a roller die at a reduction ratio above 18% per pass, there occurs a rupture of the sheath. When a complex billet is formed as calculated on a basis of the final multifilamentary flat superconductor filling factor of below 25% one fails to obtain a required amount of ceramic filaments while an increase in the filling factor above 70% results in reaching-through of the filaments which affects the configuration of a conductor. When reducing a complex billet to the required thickness by lengthwise—cross rolling, or lengthwise rolling, or cross rolling, or drawing through a roller die at a reduction ratio below 1% per pass, the geometrical dimensions of a conductor are affected and the so-called wavy shape as for length occurs. Upon reducing a complex billet by lengthwise—cross rolling, or lengthwise rolling, or cross rolling at a reduction ratio above 18% per pass, or by being drawn through a roller die at a reduction ratio above 16% per pass, there occurs a rupture of the sheath.

Thermomechanical treatment carried out at a temperature below 920° C. or above 960° C. within a total period of time shorter than 250 hours or longer than 300 hours makes it impossible to form a superconducting phase of the required composition and structure inside a ceramic core. When intermediate reduction procedures at the thermomechanical treatment stage are carried out by lengthwise—cross rolling, or lengthwise rolling, or cross rolling at a reduction ratio below 1% per pass, or by being drawn through a roller die at a reduction ratio below 2% per pass, the geometrical dimensions of a conductor are affected and the so-called wavy shape as for length occurs. When intermediate reduction procedures are carried out by lengthwise—cross rolling, or lengthwise rolling, or cross rolling at a reduction ratio above 20% per pass, or by being drawn through a roller die at a reduction ratio above 15% per pass a breakage of the sheath occurs.

To produce a high-temperature superconductor on the Bi-2212 type ceramics base, a hollow metallic ampoule is filled with a superconducting compound powder or a semi-product of Bi-2212 composition bismuth ceramics calculated on a basis of the final monofilamentary conductor filling factor of 20-60%, an ampoule—powder system is reduced to a thickness of 0.45-5 mm at a reduction ratio of 1-15% per pass, a complex billet is formed as calculated on a basis of the final multifilamentary flat superconductor filling factor of 25-55%, a complex billet is reduced to the required dimensions at a reduction ratio of 1-12% per pass; thermomechanical treatment is carried out at a temperature of 840-890° C. for a total period of time of 50-150 hours with intermediate reduction procedures carried out at a reduction ratio of 1-15% per pass. In this case an ampoule—powder system is reduced by lengthwise—cross rolling, or lengthwise rolling, or cross rolling at a reduction ratio of 2-14% per pass, a complex billet is reduced to the required dimensions by lengthwise—cross rolling, or lengthwise rolling, or cross rolling at a reduction ratio of 1-15% per pass, or by being drawn through a roller die at a reduction ratio of 2-14% per pass, a complex billet is reduced to the required dimensions by lengthwise—cross rolling, or lengthwise rolling, or cross rolling at a reduction ratio of 1-12% per pass, or by being drawn through a roller die at a reduction ratio of 2-11% per pass, intermediate reduction procedures of thermomechanical treatment is carried out by lengthwise—cross rolling, or lengthwise rolling, or cross rolling at a reduction ratio of 1-15% per pass, or by being drawn through a roller die at a reduction ratio of 2-11% per pass.

When a hollow metallic ampoule is filled with a powder of a superconducting compound or a semi-product of Bi-2212 composition bismuth ceramics calculated on a basis of the final monofilamentary conductor filling factor of below 20% a ceramic core is liable to rupture; at a monofilamentary conductor filling factor increased to more than 60%, one fails to attain the specified thickness of ceramics after reducing an ampoule—powder system. Upon reducing the resultant ampoule—powder system to a thickness of 0.45-5 mm by lengthwise—cross rolling, or lengthwise rolling, or cross rolling at a reduction ratio below 1% per pass, or by being drawn through a roller die at a reduction ratio below 2% per pass, the geometrical dimensions of a conductor are affected and the so-called wavy shape as for length occurs. Upon reducing an ampoule—powder system by lengthwise—cross rolling, or lengthwise rolling, or cross rolling at a reduction ratio above 15% per pass, or by being drawn through a roller die at a reduction ratio above 14% per pass the sheath is liable to rupture. Upon forming a complex billet calculated on a basis of the final multifilamentary flat superconductor filling factor of below 25% one fails to produce a required amount of ceramic filaments while with an increase in the filling factor above 55%, filaments are reached-through which affects the configuration of a conductor. Upon reducing a complex billet to the specified thickness by lengthwise—cross rolling, or lengthwise rolling, or cross rolling at a reduction ratio below 1% per pass, or by being drawn through a roller die at a reduction ratio below 2% per pass the geometrical dimensions of a conductor are affected and the so-called wavy shape as for length occurs. Upon reducing a complex billet by lengthwise cross rolling, or lengthwise rolling, or cross rolling at a reduction ratio above 2% per pass, or by being drawn through a roller die at a reduction ratio above 11% per pass, the sheath is liable to rupture. Thermomechanical treatment carried out at a temperature below 840° C. or above 900° C. during a total period of time below 50 hours or more than 150 hours fails to make it possible for a superconducting phase having the specified composition and structure to be formed within a ceramic core. When intermediate reduction procedures are carried out at the thermomechanical stages by lengthwise—cross rolling, or lengthwise rolling, or cross rolling at a reduction ratio below 1% per pass, or by being drawn through a roller die at a reduction ratio below 2% per pass, the geometrical dimensions of a conductor are affected and the so-called wavy shape as for length occurs. When intermediate reduction procedures are carried out by lengthwise—cross rolling, or lengthwise rolling, or cross rolling at a reduction ratio above 15% per pass, or by being drawn through a roller die at a reduction ratio above 11% per pass, the sheath is liable to rupture.

To produce a high-temperature superconductor on the base of Bi-2223 ceramics, a hollow metallic ampoule is filled with a superconducting compound powder or a semi-product of the bismuth ceramics Bi-2223 composition calculated on a basis of the final monofilamentary conductor filling factor of 25-75%; the ampoule-powder system is reduced to a thickness of 0.35-4 mm at a reduction ratio of 2-20% per pass; the formation of a complex billet is carried out as calculated on a basis of the final multifilamentary flat superconductor filling factor of 30-70%; the complex billet is reduced to the required dimensions at a reduction ratio of 2-18% per pass; thermomechanical treatment is carried out at a temperature of 800-850° C. for a total period of time of 150-350 hours with intermediate reduction procedures at a reduction ratio of 220% per pass. In this case the ampoule—powder system is reduced by lengthwise—cross rolling, or lengthwise rolling, or cross rolling at a reduction ratio of 2-20% per pass, or by being drawn through a roller die at a reduction ratio of 2-18% per pass; the complex billet is reduced to the required dimensions by lengthwise—cross rolling, or lengthwise rolling, or cross rolling at a reduction ratio of 2-18% per pass, or by being drawn through a roller die at a reduction ratio of 2-16% per pass; the intermediate reduction procedures of thermomechanical treatment is carried out by lengthwise cross rolling, or lengthwise rolling, or cross rolling at a reduction ratio of 2-20% per pass, or by being drawn through a roller die at a reduction ratio of 4-15% per pass.

When a hollow metallic ampoule is filled with a superconducting compound powder or a semi-product of the bismuth ceramics Bi-2223 composition calculated on a basis of the final monofilamentary conductor filling factor of below 25%, a ceramic core is liable to rupture; with an increase in the monofilamentary conductor filling factor to 75%, one fails to attain the required thickness of ceramics after reducing the ampoule—powder system. Upon reducing the resultant ampoule—powder system to a thickness of 0.35-4 mm by lengthwise—cross rolling, or lengthwise rolling, or cross rolling at a reduction ratio below 2% per pass, or by being drawn through a roller die at a reduction ratio below 2% per pass, the geometrical dimensions of a wire are affected and the so-called wavy shape as for length occurs. Upon reducing an ampoule—powder system by lengthwise—cross rolling, or lengthwise rolling, or cross rolling at a reduction ratio above 20% per pass, or by being drawn through a roller die at a reduction ratio above 18% per pass, the sheath is liable to rupture. When a complex billet is formed as calculated on a basis of the final multifilamentary flat superconductor filling factor below 30%, one fails to obtain a required amount of ceramic filaments while an increase in the filling factor above 70% results in reaching-through of the filaments which disturbs the configuration of a conductor. Upon reducing a complex billet to the specified thickness by lengthwise—cross rolling, or lengthwise rolling, or cross rolling at a reduction ratio below 2% per pass, or by being drawn through a roller die at a reduction ratio below 2% per pass, the geometrical dimensions of the conductor are affected and the so-called wavy shape as for length occurs. Upon reducing a complex billet by lengthwise—cross rolling, or lengthwise rolling, or cross rolling at a reduction ratio above 18% per pass, or by being drawn through a roller die at a reduction ratio above 16% per pass, the sheath is liable to rupture. Thermomechanical treatment carried out at a temperature below 800° C. or above 850° C. during a total period of time shorter than 150 hours or more than 350 hours fails to make it possible for a superconducting phase having the specified composition and structure to form within a ceramic core. When intermediate reduction procedures are carried out at the stage of thermomechanical treatment by lengthwise—cross rolling, or lengthwise rolling, or cross rolling at a reduction ratio below 2% per pass, or by being drawn through a roller die at a reduction ratio below 4% per pass, geometrical dimensions of the conductor are affected and the so-called wavy shape as for length occurs. When intermediate reduction procedures are carried out by lengthwise—cross rolling, or lengthwise rolling, or cross rolling at a reduction ratio above 20% per pass, or by being drawn through a roller die at a reduction ratio of 15% per pass the sheath is ruptured.

Flat superconductors produced as a result of carrying out the invention accord9ng to the first embodiment thereof appear as tapes comprising a sheath where elements of superconducting ceramics are arranged in layers. The ratio between a total surface area of the elements of high-temperature superconducting ceramics and the maximum overall-dimenions of a flat superconductor is 0.15-3 m per layer of the superconducting ceramics and the ratio between a total surface area of reinforcing elements and the maximum overall-dimenions of a flat superconductor is 0.15-3 m per layer of the reinforcing elements. The width of the superconductor is up to 1.5 m. The critical current of using samples (each measuring 0.38 mm×10 mm×80 mm) cut out of the thus-produced superconductors as measured by the standard four-probe method is 568-580 A at 77K and a zero magnetic field applied.

To gain a better understanding of the invention some specific examples of its embodiment are given below.

### EXAMPLES

### Example 1

A silver ampoule (a tube 1115 mm long, 12.8 mm in diameter with the wall 1.18 mm thick) is filled with a powder, i.e., the Bi-2223 ceramics precursor calculated on a basis of the final monofilamentary conductor filling factor of 40%, the resultant ampoule—powder system is reduced to a monofilamentary conductor thickness of 1 mm by being drawn through a roller die at a reduction ratio of 2% per pass and cut into specified-lengths. A silver-sheath billet of the oval cross-section is produced by upsetting to sizes (up to the height of 14 mm) a metallic sheath billet of the round section (tube 30 mm in diameter, 237 mm long with a wall 2.2 mm thick). Then a complex billet is formed by arranging 42 specified-length component parts (each 207 mm long) of cut monofilamentary conductor into component parts (calculated on a basis of the final multifilamentary conductor filling factor of 31%) within the thus-produced sheath billet of the oval cross-section. The complex billet is reduced to a thickness of 0.38 mm by lengthwise rolling at a reduction ratio of 2% per pass. The thus-produced flat conductor is subjected to thermomechanical treatment at a temperature of 800-850° C. for a total period of time of 150-350 hours with the intermediate reduction procedures performed by lengthwise rolling at a reduction ratio of 10% per pass. A long-length flat superconductor 75 mm wide is produced which consists of a silver sheath containing elements (arranged in layers) of high-temperature superconducting ceramics based on the Bi-2223 phase, that is, 14 such elements per layer (a total amount of the elements of high-temperature superconducting ceramics makes up 42 items). The sheath surrounds completely the elements of high-temperature superconducting ceramics on all sides. The sheath is made of a material which does not degrade the superconducting properties of the elements of high-temperature superconducting ceramics the ratio between a total surface area of the elements of high-temperature superconducting ceramics to the maximum overall-dimenions of the flat superconductor makes up 0.20 m per layer of superconducting ceramics. The critical current measured by the standard four-probe method using samples (each measuring 0.38 mm×10 mm×80 mm) cut of said superconductor is 560 A.

### Example 2

A metallic ampoule made of an Arg+1% by weight Mg alloy (tube 100 mm long, 12.8 mm in diameter with the wall 1.18 mm thick) is filled with a powder precursor of the Bi-2223 bismuth ceramics calculated on a basis of the final monofilamentary filling factor of 40%; the resultant ampoule powder system is reduced to a monofilamentary conductor thickness of 1 mm by lengthwise—cross rolling at a reduction ratio of 20% per pass and cut into specified-lengths. A billet from the Ag+1% by weight Mg alloy sheath of an oval cross-section is produced by upsetting to size (the height of 14 mm) a metallic sheath billet of the round section (tube 30 mm in diameter, 100 mm long with the wall 2.2 mm thick). Then a complex billet is formed by arranging 42 specified-length component parts (each 90 mm long) of a cut monofilamentary conductor (calculated on a basis of the final multifilamentary conductor filling factor of 34%) within the thus-produced sheath billet. The complex billet is reduced to a thickness of 0.38 mm by lengthwise—cross rolling at a reduction ratio of 18% per pass. The thus-produced flat conductor is subjected to thermomechanical treatment at a temperature of 800-850° C. for a total period of time of 150-350 hours with the intermediate reduction procedures by cross rolling at a reduction ratio of 10% per pass. A short flat superconductor 75 mm wide is produced, consisting of an Ag+1% by weight Mg alloy sheath within which the elements of the Bi-2223 phase high-temperature superconducting ceramics (monofilamentary conductors sheathed with the Ag+1% by weight Mg alloy) are arranged in layers that is, 14 elements per layer (a total amount of the elements of high-temperature superconducting ceramics is 42 items). The sheath surrounds the elements of said high-temperature superconducting ceramics completely on all sides. The sheath is made of a material which does not degrade the superconducting properties of the elements of said high-temperature superconducting ceramics. The ratio between a total surface area of the elements of high-temperature superconducting ceramics and the maximum overall dimensions of the flat superconductor is 0.20 m per layer of said superconducting ceramics.

The critical current measured by the standard four-probe method using the using samples (each measuring each measuring 0.38 mm×10 mm×80 mm) cut out of this conductor was 570 A.

### Example 3

A silver ampoule (tube 1115 mm long, 12.8 mm in diameter with the wall 1.18 mm thick) is filled with a powdery precursor of the Bi-2212 ceramics calculated on a basis of the final monofilamentary conductor filling factor of 20%; the thus-produced ampoule—powder system is reduced to the monofilamentary conductor thickness of 4 mm by being drawn through a roller die at a reduction ratio of 14% per pass and cut into specified lengths. A silver sheath billet of an oval cross-section is produced by upsetting to size (up to the height of 14 mm) of a metallic round cross-section sheath billet (tube 30 mm in diameter, 237 mm long with the wall 2.2 mm thick). Then a complex billet is formed by arranging, within the thus-produced oval cross-section sheath billet, ten specified-length component parts (each 207 mm long) of a cut monofilamentary conductor (calculated on a basis of the final multifilamentary conductor filling factor of 30%). The complex billet is reduced to a thickness of 0.4 mm by being drawn through a roller die at a reduction ratio of 7% per pass. The thus-produced flat conductor is subjected to thermomechanical treatment at 840-900° C. for a total period of time of 50-150 hours with the intermediate reduction procedures by being drawn through a roller die at a reduction ratio of 11% per pass. A 75 mm wide flat superconductor is produced, consisting of a silver sheath within which the elements of high-temperature superconducting ceramics based on the Bi-2212 phase are arranged in layers, a single element per layer (a total amount of the elements of said high-temperature superconducting ceramics is ten items). The sheath surrounds the elements of said high-temperature superconducting ceramics on all sides. The sheath is made of a material which does not degrade the superconducting properties of the elements of said high-temperature superconducting ceramics. The ratio between a total surface area of the elements of said high-temperature superconducting ceramics and the maximum overall dimensions of the flat superconductor is 0.15 m per layer of said superconducting ceramics. The critical current measured by the standard four-probe method using samples (each measuring 0.4 mm×10 mm×80 mm) cut out of this conductor was 565 A.

### Example 4

A silver ampoule (tube 1115 mm long, 18 mm in diameter with the wall 1.18 mm thick) is filled with a powdery precursor of the Y-123 yttrium ceramics calculated on a basis of the final monofilamentary conductor filling factor of 20%; the resultant ampoule—powder system is reduced to the monofilamentary conductor thickness of 2.5 mm by lengthwise rolling at a reduction ratio of 7% per pass and is cut into specified-length component parts. A sheath billet of an Ag+1% by weight Mg alloy of an oval cross-section is produced by upsetting to size (up to the height of 14 mm) of a metallic sheath billet having the round cross-section (tube 100 mm long, 30 mm in diameter with the wall 2.2 mm thick). Then a complex billet is formed by means of layer-by-layer arrangement, within the thus-produced oval cross-section sheath billet, of three specified-length component parts (each 90 mm long) of flat monofilamentary conductors cut into component parts such that a single monofilamentary conductor is per layer (calculated on a basis of the final multifilamentary conductor filling factor of 39%). In this case layers of the flat elements of a Ag+1% by weight Cu reinforcing alloy elements (each 90 mm long and 0.5 mm thick) are arranged between the first and the second, the second and the third layers of said monofilamentary conductors with a single reinforcing element per layer. The complex billet is reduced to reach a thickness of 0.4 mm by being drawn through a roller die at a reduction ratio of 10% per pass. The resultant flat superconductor is subjected to thermomechanical treatment at 920-960° C. for a total period of time of 250-300 hours with the intermediate reduction procedures by lengthwise rolling at a reduction ratio of 15% per pass. The resultant 75 mm wide flat superconductor consists of an Ag+1% by weight Mg alloy sheath within which the elements of Y-123-based high-temperature superconducting ceramics (monofilamentary layers sheathed with silver) are arranged in the mode of a single element per layer (a total amount of the elements of said high-temperature superconducting ceramics is three items); in this case the layers of the flat reinforcing Ag+1% by weight Cu alloy elements are arranged between the first and the second, the second and the third layers of said flat monofilamentary conductors with a single reinforcing element per layer. The sheath surrounds the elements of said high-temperature superconducting ceramics and the reinforcing elements on all sides. The sheath and the reinforcing elements are made of a material which does not degrade the elements of the superconducting ceramics in the superconductor of the particular design the ratio between a total surface area of the of said high-temperature superconducting ceramics and the maximum overall dimensions of the flat superconductor is 0.15 m per layer of the superconducting ceramics; the ratio between a total surface area of the reinforcing elements and the maximum overall dimensions of the flat superconductor is 0.15 m per layer of the reinforcing elements. The magnetic induction measurements of the critical current using samples (each measuring 0.4 mm×20 mm×80 mm) cut out of the superconductor showing the critical current to be 568 A.

### Example 5

A silver ampoule (tube 1115 mm long, 12.8 mm in diameter with the wall 1.18 mm thick) is filled with a powdery precursor of the Bi-2212 bismuth ceramics calculated on a basis of the final monofilamentary conductor filling factor of 60%; the resultant ampoule—powder system is reduced to a monofilamentary conductor thickness of 1 mm by being drawn through a roller die at a reduction ratio of 2% per pass and is cut into specified-length component parts. An oval cross-section Ag+1% by weight Mg alloy sheath billet is produced by upsetting to size (up to the height of 14 mm) of a metallic sheath billet having the round cross-section (tube 30 mm in diameter, 100 mm long with the wall 2.2 mm thick). Then a complex billet is formed by means of layer-by-layer arranging, within the thus-produced oval cross-section sheath billet, 36 specified-length component parts (each 90 mm long) of cut monofilamentary conductor, i.e., six layers with six specified-length component parts per layer (calculated on a basis of the final multifilamentary conductor filling factor of 30%). In this case, layers of reinforcing Ag+1% by weight Ni alloy elements, i.e., five layers with six reinforcing elements (appearing as rods) per layer (90 mm long and 0.5 mm thick) are arranged between the first and the second, the second and third, the third and the fourth, the fourth and the fifth, the fifth and the sixth layers of the monofilamentary conductor. The complex billet is reduced to a thickness of 0.4 mm by lengthwise rolling at a reduction ratio of 2% per pass. The thus-produced flat conductor is subjected to thermomechanical treatment at 840-900° C. during a total period of time of 50-150 hours with the intermediate reduction procedures by being drawn though a roller die at a reduction ratio of 11% per pass. The thus-produced 75 mm wide flat superconductor comprises a silver sheath within which the elements of said high-temperature superconducting ceramics based on Bi-2212 (monofilamentary conductor sheathed with an Ag+1% by weight Mg alloy) are arranged in layers, i.e., six elements per layer (a total amount of the elements of said high-temperature superconducting ceramics is 36 items); in this case layers of the reinforcing elements, that is, five layers with six reinforcing elements per layer appearing as rods made of the Ag+1% by weight Ni alloy are arranged between the first and the second, the second and the third, the third and the fourth, the fourth and the fifth, the fifth and the sixth layers of a monofilamentary conductor. The sheath surrounds the elements of said high-temperature superconducting ceramics and the reinforcing elements on all the sides thereof. The sheath and the reinforcing elements are made of a material which does not degrade the superconducting properties of the elements of the high-temperature superconducting ceramics in the superconductor of the particular design, the ratio between a total surface area of the elements of said high-temperature superconducting ceramics and the maximum overall dimensions of the flat supeconductor being 0.20 m per layer of said superconducting ceramics; the ratio between a total surface area of the reinforcing elements and a maximum overall dimenions of the flat superconductor is 0.10 m per layer of the reinforcing elements. The critical current measured by the standard four-probe method using the using samples (each measuring 0.4 mm×10 mm×80 mm) cut out of the superconductor is 570 A.

### Example 6

A silver ampoule (tube 1115 mm long, 12.8 mm in diameter with the wall 1.18 mm thick) is filled with a powdery precursor of the Y-123 yttrium ceramics calculated on a basis of the final monofilamentary conductor filling factor of 60%; the resultant ampoule—powder system is reduced to a monofilamentary conductor thickness of 1 mm by lengthwise rolling at a reduction ratio of 1% per pass and is cut into specified-length component parts. A silver sheath billet of the oval cross-section is produced by upsetting to size (to the height of 14 mm) of a metallic sheath billet having the round cross-section (tube 30 mm in diameter, 237 mm long with the wall 2.2 mm thick). Then a complex billet is formed by means of layer-by-layer arrangement of a total of 36 specified-length component parts (each 207 mm long) of a monofilamentary conductor cut into component parts with in the thus-produced oval cross-section sheath billet, i.e., six layers with six specified-length component parts per layer (calculated on a basis of the final multifilamentary conductor filling factor of 33%). In this case layers of flat Ag+1% by weight Ni alloy reinforcing elements (each 207 mm long and 0.5 mm thick) are arranged between the first and the second, the second and the third, the third and the fourth, the fourth and the fifth, the fifth and the sixth layers of said monofilamentary conductor with a single reinforcing element per layer. The complex billet is reduced to a thickness of 0.4 mm by being drawn through a roller die at a reduction ratio of 7% per pass. The thus-produced flat conductor is subjected to thermomechanical treatment at 920-960° C. during a total period of time of 250-300 hours with the intermediate reduction procedures by lengthwise rolling at a reduction ratio of 1% per pass. The thus-produced 75 mm wide flat superconductor comprises a silver sheath within which the elements of said high-temperature superconducting ceramics based on the Y-123 phase are layer-by-layer arranged with six elements per layer (a total amount of the elements of said high-temperature superconducting ceramics is 36 items); in this case the layers of the reinforcing elements, i.e., five layers each having a single reinforcing element in the form of flat plates from an Ag+1% by weight Ni alloy.

The sheath surrounds the elements of said high-temperature superconducting ceramics and said reinforcing elements on all sides. The sheath and the reinforcing elements are made of a material which does not degrade the supeconducting properties of the elements of said high-temperature superconducting ceramics in the superconductor of the particular design, the ratio between a total surface area of the high-temperature superconducting ceramic elements and the maximum overall dimensions of the flat superconductor being 0.20 m per layer of the superconducting ceramics; the ratio between a total surface area of the reinforcing elements and the maximum overall dimensions of the flat superconductor being 0.15 m per layer of the reinforcing elements. Magnetic induction measurements of the critical current using samples (each measuring 0.4 mm×20 mm×80 mm) cut out of said conductor show the samples to carry a current of 585 A.

### Example 7

A silver ampoule (box 2000 mm long, 700 mm wide, 10 mm high with the wall 1.2 mm thick) is filled with a powdery precursor of the Bi-2223 bismuth ceramics calculated on a basis of the final monofilamentary conductor filling factor of 40%; the resultant ampoule—powder system is reduced to a monofilamentary conductor thickness of 1 mm by being drawn through a roller die at a reduction ratio of 7% per pass and cut into specified-length component parts. Then a complex billet is formed by arranging in layers (a single specified-length component part per layer) 19 specified-length component parts (1189 mm long) of a flat monofilamentary conductor cut into component parts (calculated on a basis of the final multifilamentary conductor filling factor of 37%) within a silver sheath billet (box 1200 mm long, 800 mm wide, 25 mm high with the wall 2.5 mm thick). The complex billet is then reduced to a thickness of 0.38 mm by lengthwise—cross rolling at a reduction ratio of 10% per pass. The thus-produced flat conductor is subjected to thermomechanical treatment at 800-850° C. during a total period of time of 250-300 hours with the intermediate reduction procedures by being drawn through a roller die at a reduction ratio of 15% per pass. The thus-produced flat superconductor 1000 mm wide comprises a silver sheath within which the elements of said high-temperature superconducting ceramics based on Bi-2223 are arranged in layers with a single element per layer (a total amount of the elements of said high-temperature superconducting ceramics is 19 items). The sheath surrounds the elements of said high-temperature superconducting ceramics and the reinforcing elements on all sides thereof. The sheath is made of a material which does not degrade the superconducting properties of the elements of said high-temperature superconducting ceramics, the ratio between a total surface area of the elements of said high-temperature superconducting ceramics and the maximum overall dimensions of said flat superconductor is 2 m per layer of said superconducting ceramics. The critical current as measured by the standard four-probe method using samples (each measuring 0.4 mm×10 mm×80 mm) cut out of this superconductor is 560 A.

### EXAMPLE 8

A silver ampoule (box 2000 mm long, 1050 mm wide, 10 mm high with the wall 1.2 mm thick) is filled with a powdery precursor of the Bi-2223 bismuth ceramic calculated on a basis of the final monofilamentary conductor filling factor of 40%; the resultant ampoule—powder system is reduced to a thickness of 1 mm by being drawn through a roller die at a reduction ratio of 7% per pass and is cut into specified-length component parts. Then a complex billet is formed by arranging in layers (a single specified-length part per layer) ten specified-length component parts (each 1180 mm long) of a flat monofilamentary conductor cut into component parts (calculated on a basis of the final multifilamentary conductor filling factor of 29%) within a silver sheath billet (box 1200 mm long, 1200 mm wide, 25 mm high with the wall 2.5 mm thick). In this case between all the layers of said flat monofilamentary conductor the flat layers of reinforcing Ag+1% by weight Cu alloy elements (1180 mm long, 1 mm thick) are distributed with a single reinforcing element per layer—there are a total of nine layers of the reinforcing elements. The complex billet is reduced to a thickness of 0.38 mm by being drawn through a roller die at a reduction ratio of 10% per pass. The thus-produced flat conductor is subjected to thermomechanical treatment at 800-850° C. during a total period of time of 250-300 hours with the intermediate reduction procedures by lengthwise rolling at a reduction ratio of 1% per pass. The thus-produced flat superconductor 1500 mm wide comprises a silver sheath within which the elements of said high-temperature superconducting ceramics based on Bi-2223 are arranged in layers, with a single element per layer (a total amount of the elements of said high-temperature superconducting ceramics is ten items); in this case between all the layers of the flat monofilamentary conductor the flat layers of the reinforcing Ag+1% by weight Cu alloy elements are distributed with a single reinforcing element per layer so that there are a total of nine layers of reinforcing elements. The sheath surrounds the elements of said high-temperature superconducting ceramics and said reinforcing elements on all sides thereof. The sheath and the reinforcing elements are made of a material which does not degrade the superconducting properties of the elements of said high-temperature superconducting ceramics used in the superconductor of the particular design, the ratio between a total surface area of the elements of high-temperature superconducting ceramics and the maximum overall dimensions of the flat superconductor is 3 m per layer of said superconducting ceramics; the ratio between a total surface area of the reinforcing elements and the maximum overall dimensions of the flat superconductor is 3 m per layer of the reinforcing elements. The critical current as measured by the standard four-probe method using samples (each measuring 0.4 mm×10 mm×80 mm) cut out of this superconductor is 580 A.

### INDUSTRIAL APPLICABILITY

As a result of carrying out the invention, wide tapes (from 7.5 mm to 1 m and up to 1.5 m when using the reinforcing elements) are produced of a specified length (from dozens of centimetres to dozens of metres). The critical current density of all the thus-produced tapes was not below 560 A.

The superconductors were used to produce magnetic shielding as rectangular, round and polygon sheets having the perimeters of 4 m, 2.5 m, and 3 m, respectively. Furthermore, the superconductors were used to cut out plates without inner holes having the perimeters of 2.5 m, 3 m, and 4 m and the shape of rectangles, disks, polygons and ellipses, respectively, as well as having the perimeters of 1.8 m, 2.3 m, 2.8 m and 3.8 m, respectively, 1.6 m, 2.1 m, 2.6 m, and 3.6 m, respectively, 1.4 m, 1.9 m, 2.4 m and 3.4 m, respectively, and 1.2 m, 1.7 m, 2.2 m, and 3.2 m, respectively. Plates with inner holes were also cut out of the superconductors; the perimeters of the plates in the form of rectangles, disks, polygons and ellipses are 2 m, 2.5 m, 3 m and 4 m, respectively, as well as 1.8 m, 1.9 m, 2.4 m and 3.4 m, respectively, and 1.2 m, 1.7 m, 2.2 m and 3.2 m, respectively; the perimeters of the inner holes in the form of rectangles, circles, polygons and ellipses are 0.5 m, 1 m, 1.5 m, 2 m, respectively, as well as 0.4 m, 0.9 m, 1.4 m and 1.9 m, respectively, 0.3 m, 0.8 m, 1.3 m, 1.8 m, 0.2 m, 0.7 m, 1.2 m and 1.7 m, respectively, 0.1 m, 0.6 m, 1.1 m, and 1.6 m, respectively. Using the plates having the identical shapes, similar and dissimilar geometrical dimensions with or without holes arrays of plates were stacked by laying one plate on another; using plates of dissimilar geometrical dimensions, piles were stacked by increasing gradually the dimensions of the plates. Plates stacked in arrays were annealed and used as constituent components of electrical machines by putting arrays of plates with inner holes onto steel rods of the shape corresponding to the hole of the plate array. Also upon stacking the arrays the plates are interleaved with steel sheets having dimensions and shapes similar and dissimilar to those of plates; and electrical machine components are assembled by putting arrays of plates with inner holes onto steel rods of a shape corresponding to the hole of the plate array. Also the plates are interleaved with polymer film interlayers, i.e., polyethylene, an insulant material, i.e., fluorinated plastic, high-strength steel and plate arrays of that kind are used in magnetic screens.

1. A method of producing a flat superconductor comprising forming a hollow metallic ampoule, filling the ampoule with superconducting compound or semi-product powder, reducing the resultant ampoule—powder system to the required dimensions, cutting the reduced ampoule—powder system into specified-length component parts, forming a complex billet by placing a required amount of specified-lengths component parts inside the sheath, reducing the complex billet to the required dimensions, and thermomechanical treatment, wherein said hollow metallic ampoule is filled with a superconducting compound or semi-product powder calculated on a basis of the final monofilamentary conductor filling factor of 20-75%, said ampoule—powder system is reduced to a thickness of 0.35-5 mm at a reduction ratio of 1-20% per pass; said sheath for said complex billet appears as a hollow section having an elliptical or rectangular cross-section, where a required amount of specified-length component parts of the reduced ampoule—powder system or a required amount of specified-length component parts of the reduced ampoule—powder system and reinforcing elements are arranged, being calculated on a basis of the final multifilamentary flat superconductor filling factor of 26-70%; said complex billet is reduced to the required dimensions at a reduction ratio of 1-18% per pass, while thermomechanical treatment is carried out in a number of stages with intermediate reduction procedures therebetween at such a temperature and for such a period of time that ensure the required composition and structure.

2. A method of producing a flat superconductor as claimed in claim 1, wherein the ampoule—powder system is reduced by lengthwise—cross rolling, or cross rolling, or lengthwise rolling at a reduction ratio of 1-20% per pass.

3. A method of producing a flat superconductor as claimed in claim 1, wherein the ampoule—powder system is reduced by being drawn through a roller die at a reduction ratio of 1-18% per pass.

4. A method of producing a flat superconductor as claimed in claim 1, wherein a metallic elliptical-cross-section sheath for a complex billet is produced from a round cross-section billet by its being upset to size.

5. A method of producing a flat superconductor as claimed in claim 1, wherein said complex billet is reduced to the required dimensions by lengthwise—cross rolling, or cross rolling, or lengthwise rolling at a reduction ratio of 1-18% per pass.

6. A method of producing a flat superconductor as claimed in claim 1, wherein said complex billet is reduced to the required dimensions by being drawn through a roller die at a reduction ratio of 1-16% per pass.

7. A method of producing a flat superconductor as claimed in claim 1, wherein intermediate reduction procedures of thermomechanical treatment is carried out by lengthwise cross rolling, or lengthwise rolling, or cross rolling at a reduction ratio of 1-20% per pass.

8. A method of producing a flat superconductor as claimed in claim 1, wherein intermediate reduction procedures of thermomechanical treatment is carried out by drawing through a roller die at a reduction ratio of 2-15% per pass.

9. A method of producing a flat superconductor as claimed in claims 1-8, wherein a hollow metallic ampoule is filled with a powder of yttrium ceramics of the Y-123 composition and thermomechanical treatment is carried out at a temperature of 920-960° C. for 250-300 hours.

10. A method of producing a flat superconductor as claimed in claims 1-8, wherein a hollow metallic ampoule is filled with a powder of superconducting compound or semi-product of bismuth ceramics of the Bi-2212 composition calculated on a basis of the final monofilamentary conductor filling factor of 20-60%, the ampoule—powder system is reduced to a thickness of 0.45-5 mm at a reduction ratio of 1-15% per pass; the complex billet is formed as calculated on a basis of the final multifilamentary flat superconductor filling factor 25-55%; the complex billet is reduced to the required dimensions at a reduction ratio of 1-12% per pass; thermomechanical treatment is carried out at a temperature of 840-900° C. for 50-150 hours with the intermediate reduction procedures of 1-15% per pass.

11. A method of producing a flat superconductor as claimed in claims 1-8, wherein a hollow metallic ampoule is filled with a powder of superconducting compound or semi-product of bismuth ceramics of the Bi-2223 composition calculated on a basis of the final monofilamentary conductor filling factor of 25-75%, the ampoule—powder system is reduced to a thickness of 0.35-4 mm at a reduction ratio of 2-20% per pass; the complex billet is formed as calculated on a basis of the final multifilamentary flat superconductor packing factor of 30-70%; the complex billet is reduced to the required dimensions at a reduction ratio of 2-18% per pass; thermomechanical treatment is carried out at a temperature of 800-850° C. for a total period of time of 150-350 hours with the intermediate reduction procedures at a reduction ratio of 2-20% per pass.

12. A flat superconductor consisting of the elements of high-temperature superconducting ceramics arranged in layers inside a sheath, having the ratio between a total surface area of said high-temperature superconducting ceramics and the maximum overall dimensions of flat superconductor equalling 0.03-2 m per layer of said superconducting ceramics, produced by a method comprising formation of a hollow metallic ampoule, filling the ampoule with powder of a superconducting compound or semi-product calculated on a basis of the final monofilamentary conductor filling factor of 20-75%, reducing the thus-produced ampoule—powder system to a thickness of 0.35-5 mm at a reduction ratio of 1-20% per pass, cutting the reduced ampoule—powder system into specified-length component parts, forming a complex billet by placing in the complex billet sheath appearing as a hollow section of an elliptical or rectangular cross section a required amount of specified-length component parts of the reduced ampoule powder system calculated on a basis of the final multifilamentary flat superconductor filling factor of 25-70%, reducing said complex billet to the required dimensions at a reduction ratio of 1-18% per pass, thermomechanical treatment being carried out at several heat-treatment stages with intermediate reduction procedures therebetween at such a temperature and for such a period of time that ensure forming a superconducting phase in ceramics having a required composition and structure.

13. A flat superconductor as claimed in claim 12 produced by a method, wherein the ampoule—powder system is reduced by lengthwise—cross rolling, or cross rolling, or lengthwise rolling at a reduction ratio of 1-20% per pass.

14. A flat superconductor as claimed in claim 12 produced by a method, wherein the ampoule—powder system is reduced by being drawn through a roller die at a reduction ratio of 1-18% per pass.

15. A flat superconductor as claimed in claim 12 produced by a method, wherein a metal sheath for the complex billet of an elliptical cross-section is produced from a round cross-section billet by its being upset to size.

16. A flat superconductor as claimed in claim 12 produced by a method, wherein the reduction of a complex billet to a required dimensions is carried out by lengthwise cross rolling, or cross rolling, or lengthwise rolling at a reduction ratio of 1-18% per pass.

17. A flat superconductor as claimed in claim 12 produced by a method, wherein the reduction of a complex billet to a required dimensions is carried out by drawing through a roller die at a reduction ratio of 1-16% per pass.

18. A flat superconductor as claimed in claim 12 produced by a method, wherein intermediate reduction procedures of thermomechanical treatment is carried out by lengthwise—cross rolling, or lengthwise rolling, or cross rolling at a reduction ratio of 1-20% per pass.

19. A flat superconductor as claimed in claim 12 produced by a method, wherein intermediate reduction procedures of thermomechanical treatment is carried out by drawing through a roller die at a reduction ratio of 2-15% per pass.

20. A flat superconductor as claimed in claim 12 produced by a method, wherein a hollow metallic ampoule is filled with a powder of yttrium ceramics of the Y-123 composition and thermomechanical treatment is carried out at a temperature of 920-960° C. for 250-300 hours.

21. A flat superconductor as claimed in claim 12 produced by a method, wherein a hollow metallic ampoule is filled with a powder of superconducting compound or semi-product of bismuth ceramics of the Bi-2212 composition calculated on a basis of the final monofilamentary conductor filling factor of 20-60%, the ampoule—powder system is reduced to a thickness of 0.45-5 mm at a reduction ratio of 1-15% per pass, a complex billet is formed as calculated on a basis of the final multifilamentary flat superconductor filling factor of 25-55%, the complex billet is reduced to a required dimensions at a reduction ratio of 1-12% per pass, and thermomechanical treatment is carried out at a temperature of 840-900° C. for 50-150 hours with intermediate reduction procedures at a reduction ratio of 1-15% per pass.

22. A flat superconductor as claimed in claim 12 produced by a method, wherein a hollow metallic ampoule is filled with a powder of superconducting compound or semi-product of bismuth ceramics of the Bi-2223 calculated on a basis of the final monofilamentary conductor filling factor of 25-75%, an ampoule—powder system is reduced to a thickness of 0.35-4 mm at a reduction ratio of 2-20% per pass; a complex billet is formed as calculated on a basis of the final multifilamentary flat superconductor filling factor of 30-70%; the complex billet is reduced to the required dimensions at a reduction ratio of 2-18% per pass; and thermomechanical treatment is carried out at a temperature of 800-850° C. for a total period of time of 150-350 hours with the intermediate reduction procedures at a reduction ratio of 2-20% per pass.

23. A flat superconductor consisting of the elements of high-temperature superconducting ceramics enclosed in a sheath in layers, and reinforcing elements arranged in layers between the elements of said high-temperature superconducting ceramics, having the ratio between a total surface area of the elements of said high-temperature superconducting ceramics and the maximum overall dimensions of the flat superconductor equalling 0.03 m-3 m per layer of said superconducting ceramics and the ratio between a total surface area of the reinforcing elements and the maximum overall dimensions of said flat superconductor equalling 0.03 m-3 m per layer of reinforcing elements, produced by a method comprising formation of a hollow metallic ampoule, filling the ampoule with the powder of a superconducting compound or semi-product calculated on a basis of the final monofilamentary conductor filling factor of 20-75%, reducing the thus-produced ampoule-powder system to a thickness of 0.35-5 mm at a reduction ratio of 1-20% per pass, cutting the reduced ampoule—powder system into specified-length component parts, forming a complex billet by placing in a complex billet sheath appearing as a hollow section of an elliptical or rectangular cross section a required amount of specified-length component parts of the reduced ampoule—powder system and reinforcing elements calculated on a basis of the final multifilamentary flat superconductor filling factor of 25-70%, reducing the complex billet to the required dimensions at a reduction ratio of 1-18% per pass, thermomechanical treatment being carried out in a number of heat treatment stages with intermediate reduction procedures therebetween at such a temperature and for such a time that ensure forming a superconducting ceramic phase having a required composition and structure.

24. A flat superconductor as claimed in claim 23 produced by a method, wherein an ampoule—powder system is reduced by lengthwise—cross rolling, or cross rolling, or lengthwise rolling at a reduction ratio of 1-20% per pass.

25. A flat superconductor as claimed in claim 23 produced by a method, wherein an ampoule—powder system is reduced by being drawn through a roller die at a reduction ratio of 1-18% per pass.

26. A flat superconductor as claimed in claim 23 produced by a method, wherein a metal sheath of a complex billet of an elliptical cross-section is produced from a round cross-section billet by its being upset to size.

27. A flat superconductor as claimed in claim 23 produced by a method, wherein a complex billet is reduced to the required dimensions by lengthwise—cross rolling, or cross rolling, or lengthwise rolling at a reduction ratio of 1-18% per pass.

28. A flat superconductor as claimed in claim 23, produced by a method, wherein a complex billet is reduced to the required dimensions by being drawn through a roller die at a reduction ratio of 1-16% per pass.

29. A flat superconductor as claimed in claim 23 produced by a method, wherein intermediate reduction procedures of thermomechanical treatment are carried out by lengthwise—cross rolling, or lengthwise rolling, or cross rolling at a reduction ratio of 1-20% per pass.

30. A flat superconductor as claimed in claim 23 produced by a method, wherein intermediate reduction procedures of thermomechanical treatment are carried out by drawing through a roller die at a reduction ratio of 2-15% per pass.

31. A flat superconductor as claimed in claim 23 produced by a method, wherein a metallic ampoule is filled with a powder of yttrium ceramics of the Y-123 composition and thermomechanical treatment is carried out at a temperature of 920-960° C. for 250-300 hours.

32. A flat superconductor as claimed in claim 23 produced by a method, wherein a hollow metallic ampoule is filled with a powder of superconducting compound or semi-product of bismuth ceramics of the Bi-2212 composition calculated on a basis of the final monofilamentary conductor filling factor of 20-60%, an ampoule—powder system is reduced to a thickness of 0.45-5 mm at a reduction ratio of 115% per pass, a complex billet is formed as calculated on a basis of the final multifilamentary flat superconductor filling factor of 25-55%, the complex billet is reduced to the required dimensions at a reduction ratio of 1-12% per pass, thermomechanical treatment is carried out at a temperature of 840-900° C. for 50-150 hours with intermediate reduction procedures at a reduction ratio of 1-15% per pass.

33. A flat superconductor as claimed in claim 23 produced by a method, wherein a hollow metallic ampoule is filled with a powder of superconducting compound or semi-product of bismuth ceramics of the Bi-2223 composition calculated on a basis of the final monofilamentary conductor filling factor of 25-75%, an ampoule—powder system is reduced to a thickness of 0.35-4 mm at a reduction ratio of 2-20% per pass; the complex billet is formed as calculated on a basis of the final multifilamentary flat superconductor filling factor of 30-70%; the complex billet is reduced to the required dimensions at a reduction ratio of 2-18% per pass; thermomechanical treatment is carried out at a temperature of 800-850° C. for a total period of time of 150-350 hours with the intermediate reduction procedures therebetween at a reduction ratio of 2-20% per pass.

34. A flat superconductor as claimed in claim 12, wherein a sheath is made of a material which does not degrade the superconducting properties of the elements of said high-temperature superconducting ceramics.

35. A flat superconductor as claimed in claim 23, wherein the sheath and the reinforcing elements are made of a material which does not degrade the superconducting properties of the elements of high-temperature superconducting ceramics.

36. A flat superconductor as claimed in claim 12, wherein a sheath is made of silver or an alloy on the base thereof.

37. A flat superconductor as claimed in claim 23, wherein a sheath is made of silver or an alloy on the base thereof, and the reinforcing elements are made of a silver-based hardened alloy.
